(19) United States
(12) Patent Application Publication
(10) Pub. No.: US 2005/0051605 A1
(43) Pub. Date: Mar. 10, 2005

(54) Process of manufacturing a solder-fill for applying to semiconductor package

(76) Inventor: Ho-Young Lee, Seoul (KR)

Correspondence Address: GWIPS;PETER T. KWON, 1600-3 SEOCHO-DONG, SEOCHO-GU,, DAELIM BUILDING, 9TH FLOOR, SEOUL, 137-877, KR

(21) Appl. No.: 10/959,100

(22) Filed: Oct. 7, 2004

Related U.S. Application Data
(62) Division of application No. 10/351,855, filed on Jan. 27, 2003.

(30) Foreign Application Priority Data
Sep. 18, 2002 (KR) 2002-0056807
Sep. 19, 2002 (KR) 2002-0057331
Nov. 7, 2002 (KR) 2002-0068776

(51) Int. Cl. B23K 31/02

(52) U.S. Cl. 228/180.22

(57) ABSTRACT

A process of manufacturing a solder-fill is comprised of: arranging a plurality of wire or rod shaped solder bump material to match with the connection pattern of semiconductor chip and PCB in a container, filling a liquid state of under-fill material into the container, solidifying the under-fill material in the container, and slicing the solidified under-fill material and solder bump material with a uniform thickness.

This application is a divisional of application Ser. No. 10/351,855 filed Jan. 27, 2003.

### BACKGROUND OF THE INVENTION

1. Field of the Invention

The present invention relates to a process of manufacturing a solder-fill for applying to a semiconductor package. More specifically, the solder-fill is produced through specified process to mate the connection pattern of semiconductor chips with a substrate or printed circuit board.

2. Related Prior Art

Generally, a semiconductor package functions not only for protecting the semiconductor chips from its surroundings, but also for interconnecting the semiconductor chips and substrate.

In accordance with the desired goals of lowering the cost, minimizing the size and maximizing the performance and reliability, the electric interconnecting technology of area array, such as Flip Chip, Chip Scale Package (CSP) and Ball Grid Array (BGA), are developed mainly for semiconductor packages. Among the electric interconnecting technologies of area array applied to semiconductor packages, flip chip is a technology of facedown attachment in which the surface of plastic substrate having a printed circuit faces to attach the surface of a semiconductor chip, forming a microcircuit.

Of utmost interest for flip chip technology is the lifespan of thermo-mechanical fatigue at the interconnection of semiconductor chips and printed circuit board. Until the late 1980s, the thermo-mechanical fatigue was not considered a problem because flip chip technology is used silicone substrate or ceramic substrate, and the size of a semiconductor chip was relatively smaller than it is today. However, after the late 1980s, the size of the semiconductor chip has remarkably increased. Generally, a semiconductor chip having a thermal expansion coefficient of 2.5 ppm/c is used. Simultaneously, an organic substrate of FR4 having a thermal expansion coefficient of 16 ppm/° c. or Polyamide having a thermal expansion coefficient of 45 ppm/° c. was adopted as a PCB. The large difference in thermal expansion coefficients raises a problem of thermo-mechanical fatigue at the soldered interconnection between the semiconductor chip and the printed circuit board.

In order to solve the thermo-mechanical fatigue problem at the soldered interconnection, a technology for inserting an under-fill has been introduced. The under-fill is a compound in which the high molecular material of a strong adherent, such as an epoxy, is combined with SiO₂ in order to approximate the thermal expansion coefficient of solder. The compound is inserted into the gap between the semiconductor chip and the printed circuit board. It is proven that thermo-mechanical fatigue at the soldered interconnection has improved 10 to 100 times, and the deformation of solder has decreased 0.10˜0.25%, by applying an under-fill to the flip chip technique.

FIGS. 1 to 5 are cross-section views illustrating the conventional under-fill technology used to fill under-fill into an installed semiconductor chip on a substrate.

Referring to FIG. 1, a pick-up tool (30) picks up a semiconductor chip (10) that is formed with solder pumps (12) to arrange proper position on a substrate (20). The substrate (20) made of organic material forms a plurality of connections (22), which are made of copper material, for connecting the solder pumps (12) of the semiconductor chip (10).

Referring to FIG. 2, the substrate (20) loaded the semiconductor chip (10) is put into a reflow oven to melt the solder pumps (12) of semiconductor chip (10) for connecting the connections (22) of substrate (20).

Referring to FIGS. 3 and 4, the under-fill material (40) contained in a dispenser (50) is injected into the gap between the semiconductor chip (10) and the substrate (20). At this moment, it is hard to rapidly fill the narrow gap between the semiconductor chip (10) and the substrate (20) due to the thick density of under-fill material (40). Thus, the under-fill material (40) is slowly injected to penetrate throughout the narrow gap between the semiconductor chip (10) and the substrate (20), and to surround the semiconductor chip up to a certain height.

Referring to FIG. 5, when the under-fill material (40) has completely filled in the gap, a curing is processed for hardening the liquid state of under-fill material (40) and properly adhering the semiconductor chip (10) and the substrate (20).

However, the conventional mounting technology of a semiconductor chip described above has disadvantages, as listed below:

First, during the process of manufacturing a semiconductor chip, two separate heat treatments must be performed to melt the solder for connecting the semiconductor chip and the substrate, and for hardening the liquid state of under-fill material. Further, the filling process is complicated and slow because the thick density of under-fill material penetrates slowly into the narrow gap.

Second, it is difficult to maintain the uniform height of under-fill material for surrounding the semiconductor chip.

Third, due to the large difference in thermal expansion coefficients of the semiconductor chip and the substrate, the semiconductor chip and solder bump are mechanically and physically stressed during the heat treatment process. Thus, the reliability of the semiconductor package is diminished.

Fourth, it is inconvenient and increases the production cost to add the process of forming the solder bumpers on the semiconductor chip during the process of manufacturing the wafer.

### SUMMARY OF THE INVENTION

In order to solve the above-mentioned disadvantages, an objective of the present invention is to provide a solder-fill used for manufacturing a semiconductor package.

The solder-fill used for mounting a semiconductor chip on a substrate comprises under-fill material for filling the gap between the semiconductor chip and the substrate, solder bump material formed a plurality of dot or disc shapes and disposed interior of the under-fill material with same thickness to match the connecting pattern of the semiconductor chip pad.

To achieve the objective of the present invention, a process of manufacturing the solder-fill used for producing a semiconductor package is provided.

A process of manufacturing the solder-fill is that of: arranging a plurality of wire or rod shaped solder bump materials to match the connection pattern of semiconductor chips and substrate in a container, filling the liquid state of under-fill material into the container, solidifying the under-fill material in the container, cutting or slicing the solidified solder bump material and under-fill material with uniform thickness after pulling it out from the container.

Another objective of the present invention is to provide an application of solder-fill to a process for mounting a semiconductor chip on a substrate for improving the reliability of a semiconductor package and overcoming the above-mentioned disadvantages.

A process for mounting the semiconductor chip by applying solder-fill includes the steps of: preparing a printed circuit board to mount a semiconductor chip, arranging a solder-fill at a position which the semiconductor chip will be mounted on the PCB, locating the semiconductor chip above the arranged solder-fill, and reflowing (or curing) the PCB arranged with the solder-fill and the semiconductor chip.

To achieve another objective of the present invention, there is an alternative process for mounting a semiconductor chip by applying a solder-fill and an adhering means. The process comprises the steps of: preparing a printed circuit board (PCB) to mount a semiconductor chip, attaching a solder-fill at a position where the semiconductor chip will be mounted on the PCB with a adherent tape or adherent compound, positioning a semiconductor chip above the solder-fill attached on the PCB, and reflowing the PCB attached the semiconductor chip and the solder-fill.

The present invention provides another alternative process for mounting a semiconductor chip by applying solder-fill and adhering means. The mounting process comprises the steps of: attaching a solder-fill to a semiconductor chip, applying an adherent tape or adherent compound surrounding the solder-fill attached with the semiconductor chip, positioning the solder-fill being attached with the semiconductor chip on the PCB, and reflowing the PCB attached with the semiconductor chip and the solder-fill.

### BRIEF DESCRIPTION OF THE DRAWINGS

FIG. 1 through FIG. 5 are cross-section views illustrating the conventional under-fill technology used to fill the under-fill material between a semiconductor chip and a substrate.

FIG. 6 is a schematic drawing illustrating a solder-fill of the present invention.

FIG. 7 is a cross-section view of the solder-fill of the present invention.

FIG. 8 through FIG. 10 are the schematic diagrams illustrating a process of manufacturing the solder-fill according to the present invention.

FIG. 11 is a flow chart illustrating a process of mounting a semiconductor chip applied with solder-fill according to a first embodiment of the present invention.

FIG. 12 through FIG. 15 are cross-section views illustrating a process of manufacturing a semiconductor chip applied with solder-fill according to the first embodiment of the present invention.

FIG. 16 is a flow chart illustrating a process of mounting the semiconductor chip applied with solder-fill according to a second embodiment of the present invention.

FIG. 17 through FIG. 20 are cross-section views illustrating a process of mounting the semiconductor chip applied with solder-fill according to the second embodiment of the present invention.

FIG. 21 is a flow chart illustrating a process of mounting the semiconductor chip applied with solder-fill according to a third embodiment of the present invention.

FIG. 21 through FIG. 25 are cross-section views illustrating a process of mounting the semiconductor chip applied with solder-fill according to the third embodiment of the present invention.

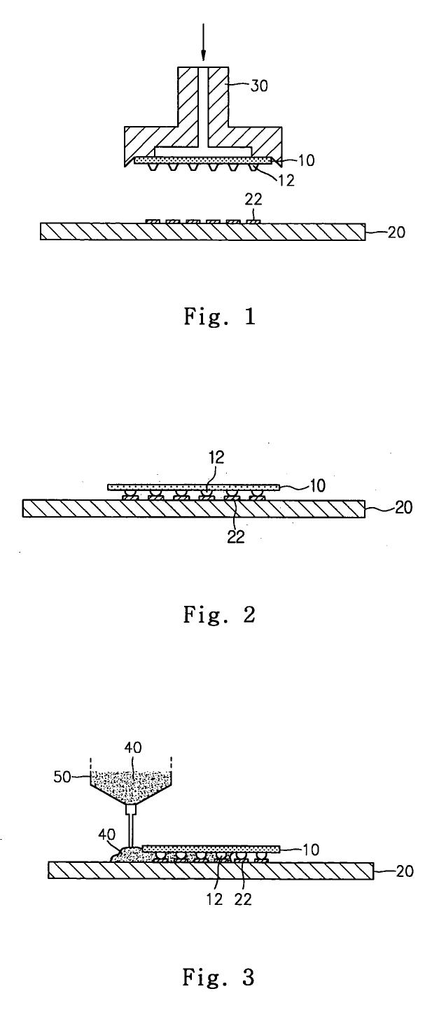

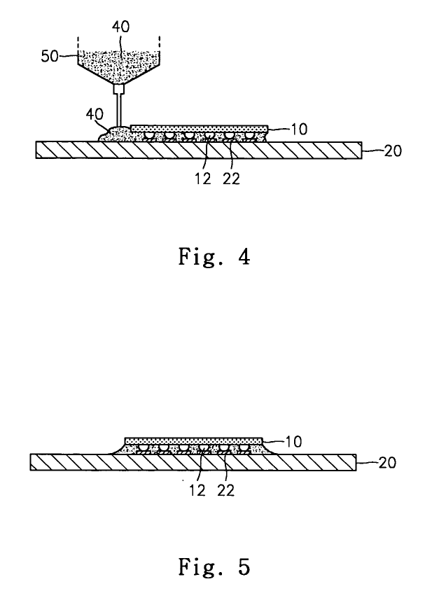

### DETAILED DESCRIPTION OF THE PREFERRED EMBODIMENT

To achieve the above-mentioned objectives, the present invention provides a solder-fill for manufacturing the semiconductor package. The solder-fill comprises under-fill material used to fill the gap between a semiconductor chip and a substrate, solder bump material formed a plurality of disc or dot shapes and disposed interior of the under-fill material with same thickness to match the connection pattern of semiconductor chip pad and the substrate.

A soft state of B-stage, such as an epoxy group material, is suitable for use as the under-fill material, which can be melted and hardened to a solid state by external heat.

A process of manufacturing solder-fill used for a semiconductor package is provided, and comprises the following steps of: a step for arranging a plurality of wire or rod shaped solder bump material to match the connection pattern of semiconductor chip and the substrate in a container, a step for filling the liquid state of under-fill material into the container, a step for solidifying the under-fill material in the container, and a step for cutting or slicing the solidified solder bump material and under-fill material to uniform thickness after pulling out from the container.

It is desirable to solidify the under-fill material to a soft state of B-stage for easily slicing or cutting. A diamond blade is used to slice the solidified solder bump material and under fill material to uniform thickness.

According to the present invention, a dispenser for filling the under-fill material and two separate heat treatments for melting the solder bump and hardening the under-fill material as used in the conventional process are not needed. Only a single heat treatment is needed to melt and harden the solder-fill for mounting the semiconductor chip on the substrate during the manufacturing process.

A process for mounting the semiconductor chip by applying a solder-fill is provided. The process comprises the steps of: a step for preparing a printed circuit board (PCB) or substrate to mount a semiconductor chip, a step for arranging a solder-fill at the position where the flip chip will be mounted on the PCB, a step for locating a semiconductor chip above the arranged solder-fill, and a step for reflowing the PCB arranged with the semiconductor chip and solder-fill.

The solder-fill consisting of the solder bump material and under fill material is cut as a thin slice with proper thickness to suitably fit between the semiconductor chip and the PCB. Thus, a semiconductor chip without the solder bump is preferable to use in this process.

Unleaded solder is suitable to use as the solder bump material. Epoxy group is suitable to use as the under-fill material in this process.

Also, the present invention is provided an alternative process for mounting a flip chip by adopting an adhering means. The mounting process comprises the following steps of: a step for preparing a printed circuit board (PCB) to mount a flip chip, a step for attaching a solder-fill at a position where the flip chip will be mounted on the PCB by using adhering means, such as an adhering tape or adherent compound, a step for positioning a semiconductor chip above the solder-fill attached on the PCB, and a step for reflowing the PCB attached to the semiconductor chip and the solder-fill.

Herein, the solder-fill is attached on the PCB by an adhering means such as an adhering tape or adherent compound underneath the surrounding edges of solder-fill. The adhering tape or adherent compound would be melted to combine with the under-fill material during the heat treatment.

The present invention is also provided another alternative process for mounting a flip chip applied with a solder-fill and adhering means. The process comprises the steps of: a step for attaching a solder-fill to a semiconductor chip, a step for applying an adhering tape or adherent compound surrounding the solder-fill attached with semiconductor chip, a step for positioning the solder-fill attached with the semiconductor chip on the PCB, and a final step for reflowing or curing the PCB attached with the semiconductor chip and the solder-fill.

Herein, the solder-fill attached to the semiconductor chip is attached onto the PCB by an adhering means such as an adhering tape or adherent compound surrounding the edges of solder-fill. The adhering tape or adherent compound would be melted to combine with the under-fill material during the heat treatment process.

According to the present invention, the flip chip is easily produced through a single heat treatment during the manufacturing process without altering the existing facilities. Because the number of heat treatments is reduced, it is possible to prevent potential thermal damage at the connections between the semiconductor chip and the PCB. Thus, it is possible to increase the reliability of the semiconductor package. Furthermore, the production cost would be reduced because the solder bumps on the semiconductor chip are not necessary in the present invention.

Hereinafter, a detailed description will be presented accompanying with the drawings for the embodiments of the present invention as follows:

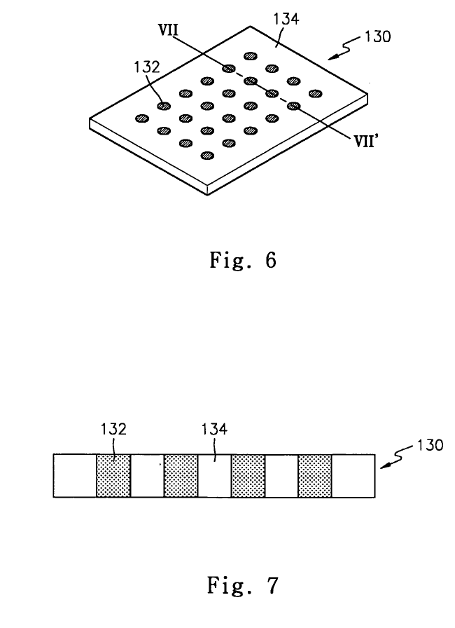

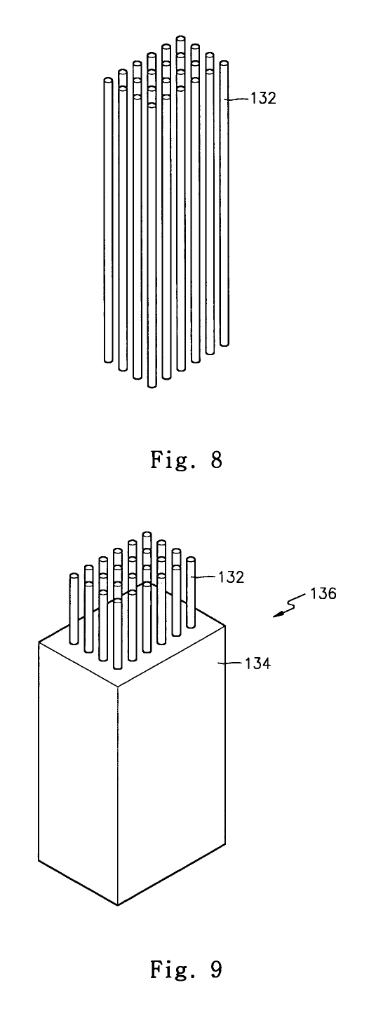

A solder-fill of the present invention is shown in FIG. 6, and a cross-section of VII-VII is shown in FIG. 7.

Referring to FIGS. 6 and 7, the solder-fill (130) used for manufacturing the semiconductor chip consists of under-fill material (134) filled between the semiconductor chip and substrate, solder bump material (132) forming a plurality of dot or disc shapes to match with a connecting pattern of semiconductor chip pad and disposed interior of under-fill material (134) with same thickness.

The solder bump material (132) can be used for forming the conventional solder bump, and could be any material, which is used to produce the wafer. The solder bump material (132) replaces the function of conventional solder bump in connecting the semiconductor chip and the substrate. Unleaded solder is suitable for use as the solder bump material.

A soft-state liquid material of B-stage, such as an epoxy group, is suitable for use as the under-fill material (134), which must be melted to fill the gap between the semiconductor chip and the substrate and hardened to a solid state by external heating.

FIGS. 8 to 10 are schematic diagrams illustrating a process of manufacturing a solder-fill according to the present invention.

Referring to FIGS. 8 to 10, a plurality of solder wires or rods (132) made of the solder bump material is arranged to match with the connection pattern of semiconductor chip pad and the PCB in a closed-bottom container, as shown in FIG. 8. Then, the liquid state of under-fill material is poured to fill the container, in which a plurality of solder wires or rods (132) is arranged. Next, the container is slightly heated to harden the liquid state of under-fill material. It is desirable to harden the liquid state of under-fill material to a soft state of B-stage.

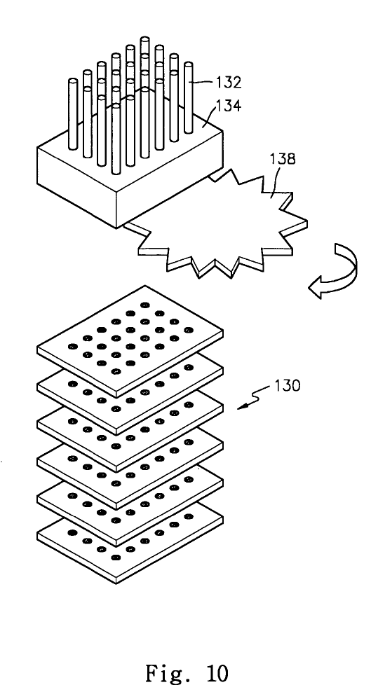

As shown in FIG. 9, the solder-fill bulk (136) consists of a solidified under-fill material (134) and a plurality of arranged solder wires or rods (132) is pulled out from the container. Then, the solder-fill bulk (136) is cut to form a unit of solder-fill (130) sliced by a diamond blade (138), as shown in FIG. 10.

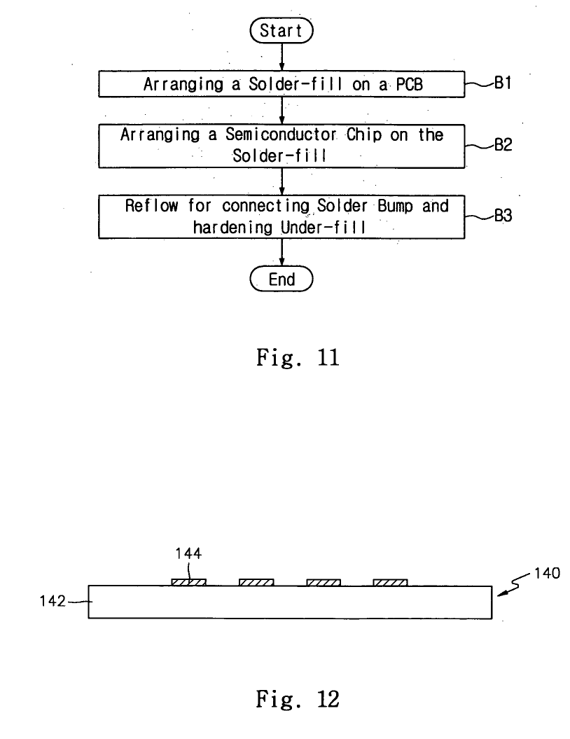

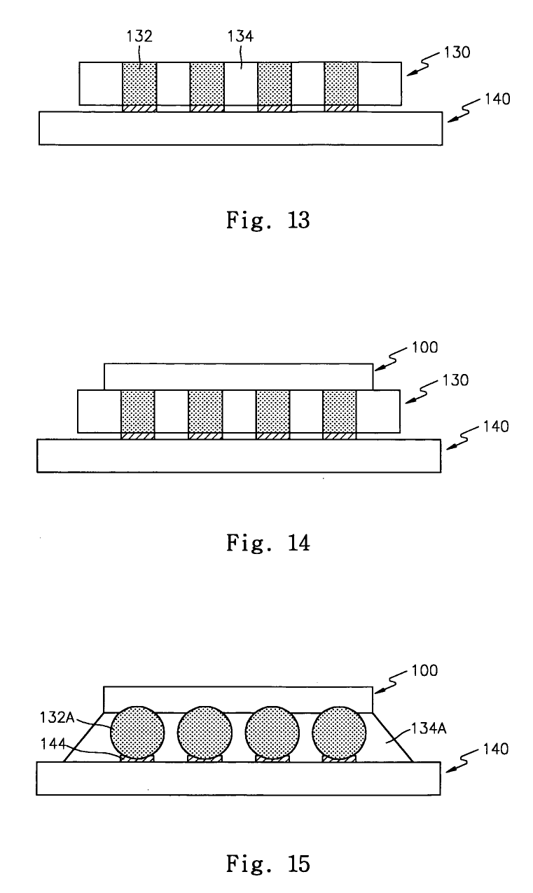

Now, referring to FIGS. 11 through 15, a process for mounting a semiconductor chip by applying a solder-fill is disclosed according to a first embodiment of the present invention.

FIG. 11 is a flow chart illustrating a process for mounting a semiconductor chip applied to solder-fill according to the first embodiment of the present invention. Referring to FIG. 11, first a semiconductor chip or flip chip, which has not formed solder bumps in an active area pad, is prepared. A PCB is prepared for mounting the semiconductor chip or flip chip. Next, a solder-fill is arranged on the PCB at a position where the semiconductor chip or flip chip will be mounted (B1). The semiconductor chip is then positioned above the arranged solder-fill to match with the connection pattern of semiconductor chip in the active area pad and PCB (B2). Finally, a reflowing is processed to harden the arranged PCB with the semiconductor chip and solder-fill (B3).

From FIGS. 12 through 15, a process for mounting a semiconductor chip applied with a solder-fill according to the first embodiment of the present invention is described in detail with a series of cross-section views. Referring to FIGS. 12 to 15, a PCB (140) comprising a substrate (142) made of organic material (FR4) and a plurality of connections (144) of circuit pattern is prepared. Next, the solder-fill (130) as shown in FIGS. 6 and 7 is arranged on the PCB (140). Sequentially, a semiconductor chip (100) is arranged above the solder-fill (130). A method of arranging the semiconductor chip (100) is such that the active area of semiconductor chip (100) pad faces down to contact the solder bumps (132) of solder-fill (130) formed by cutting the solder wire or rod. Finally, a reflowing is proceeded to harden the PCB arranged with the semiconductor chip and solder-fill. During the reflowing process, the solder bump (132A) formed by cutting the solder wire or rod is melted to connect the semiconductor chip (100) pad and the connections (144) of the PCB (140). The under-fill material (134A) is melted at the melting temperature of the solder bump (132A) to fill the gap between the semiconductor chip (100) and the PCB (140). Further, the heat treatment hardens the melted under-fill material (134A) to a solid state.

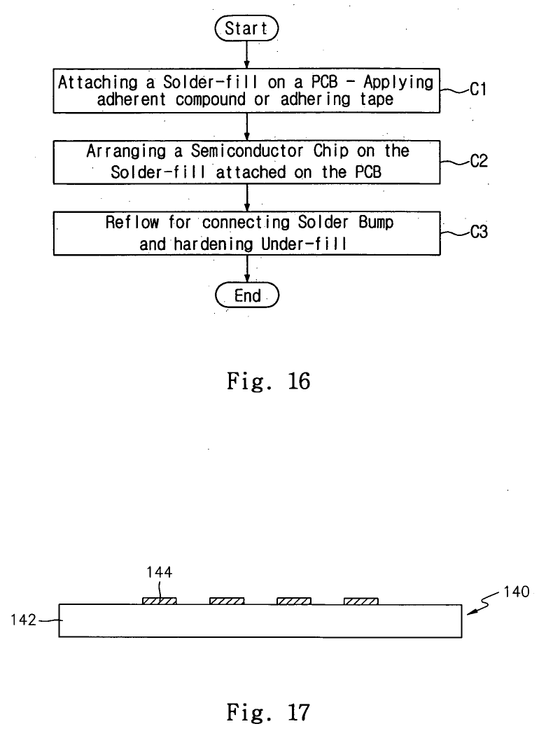

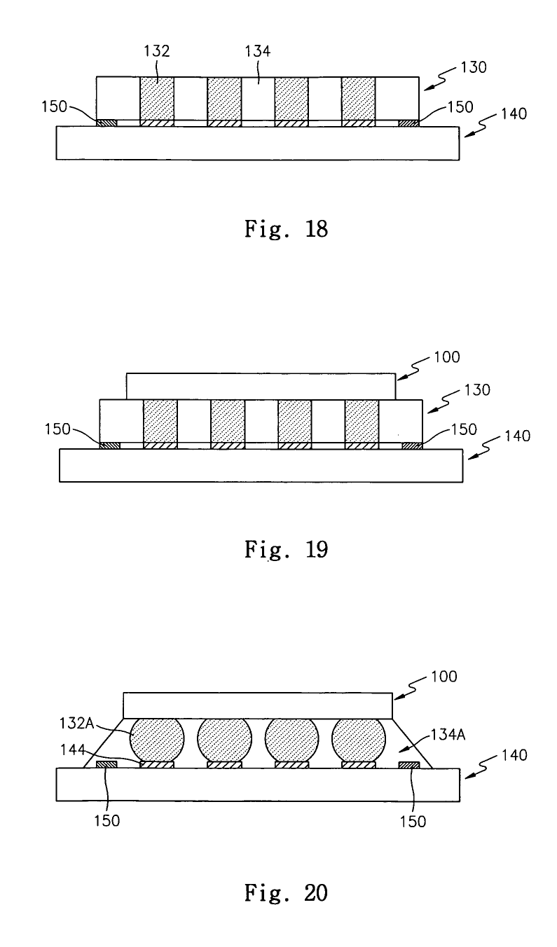

Referring to FIGS. 16 to 20, a process for mounting a semiconductor chip applied with a solder-fill is described in detail according to a second embodiment of the present invention. A flow chart as shown in FIG. 16 illustrates a process for mounting the semiconductor chip. The process for mounting the semiconductor chip applied with a solder-fill is described with a series of cross-section views, as shown in FIGS. 17 through 20. Referring to FIGS. 16 through 20, a PCB (140) comprising a substrate (142) made of organic material (FR4) and a plurality of connections (144) of circuit pattern is prepared. Next, the solder-fill (130) as shown in FIG. 6 and FIG. 7 is arranged on the PCB (140) to attach each other by adhering means (150). Then, an adhering tape or adherent compound such as an epoxy is applied to the surrounding edges of solder-fill (130) to attach on the PCB (140) (C1). Sequentially, a semiconductor chip (100) is arranged above the solder-fill (130) attached on the PCB (140) (C2). A method for arranging a semiconductor chip (100) is such that the active area of the semiconductor chip (100) pad is faced down to contact the solder bump (132) of solder-fill (130) formed by cutting the solder rod. Finally, a reflowing is proceeded to harden the PCB arranged with the semiconductor chip and solder-fill (C3). During the curing process, the solder bump (132A) formed by cutting the solder rod is melted to connect the semiconductor chip (100) pad and connections (144) of PCB (140). The under-fill material (134A) is melted at the melting temperature of the solder bump (132A) to fill the gap between the semiconductor chip (100) and the PCB (140). Further, the adhering means (150) such as an adhering tape or adherent compound used for attaching the solder-fill (130) and the PCB (140) is melted during the heat treatment to combine with the melted under-fill material (134A). It is desirable to completely melt the adhering means (150) to combine with the melted under-fill material (134A). However, it would be no problem if the adhering means (150) were partially un-melted. The melted under-fill material (134A) will be hardened during further heat treatment.

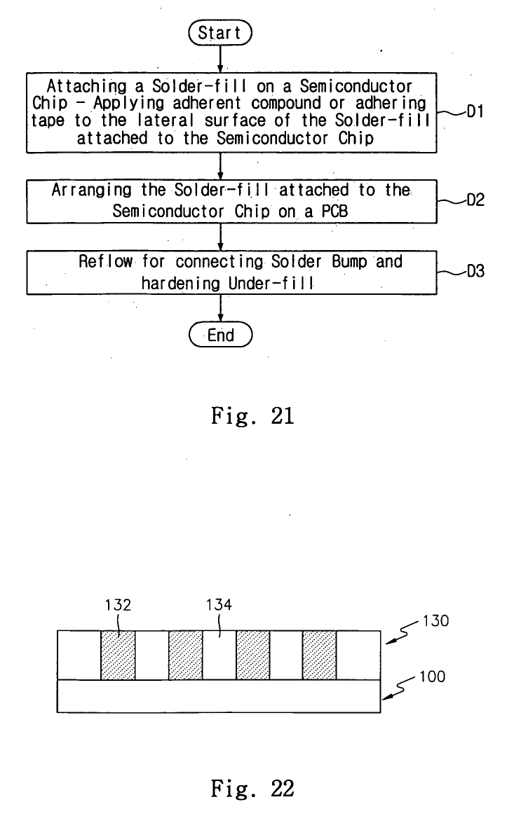

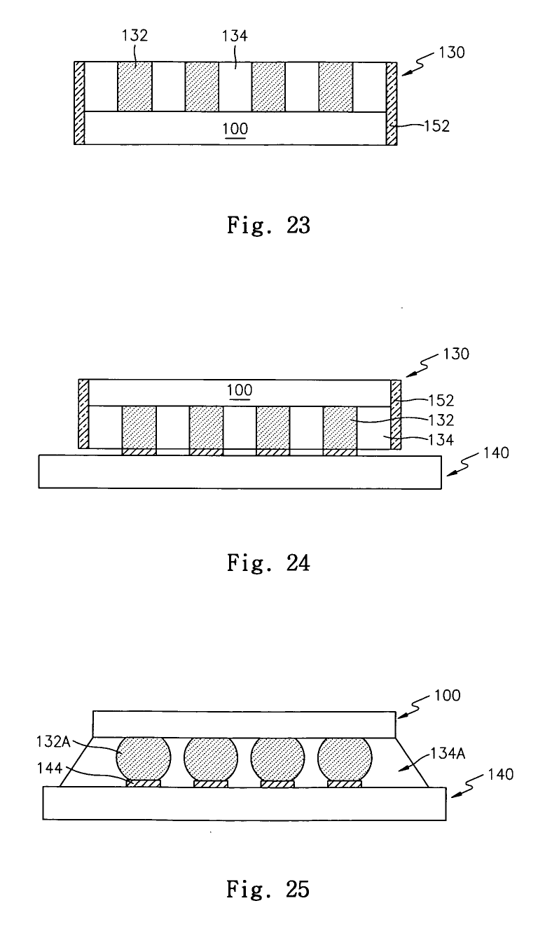

Referring to FIGS. 21 to 25, a process for mounting a semiconductor chip applied with a solder-fill is described in detail according to a third embodiment of the present invention. A flow chart as shown in FIG. 21 illustrates a process for mounting the semiconductor chip applied with solder-fill. The process for mounting the semiconductor chip applied with solder-fill of the third embodiment of the present invention is described with a series of cross-section views, as shown in FIGS. 22 to 25.

Referring to FIGS. 21 through 25, the solder-fill (130) as shown in FIGS. 6 and 7 is arranged on a semiconductor chip (100) in the manner dissimilar to that of the previous process in which the solder-fill is arranged on the substrates. The present method of arranging a semiconductor chip (100) is to position the active area of semiconductor chip (100) pad face down to contact the solder bump (132) of the solder-fill (130) formed by cutting the solder wire or rod. The lateral surface of the solder-fill (130) arranged with the semiconductor chip (100) is wrapped by adhering means (150) such as an adhering tape (152) (D1). Sequentially, the solder-fill (130) and the semiconductor chip (100) wrapped by adhering tape (152) are arranged on the PCB (140) (D2). Finally, a reflowing is proceeded to harden the PCB arranged with the semiconductor chip and solder-fill (D3). During the reflowing process, the solder bump (132A) formed by cutting the solder wire is melted to connect the pad of semiconductor chip (100) and the connections (144) of PCB (140). The under-fill material (134A) is melted at the melting temperature of the solder bump (132A) to fill the gap between the semiconductor chip (100) and the PCB (140). Further, the adhering tape (150) will be melted during the heat treatment to combine with the melted under-fill material (134A). It is desirable that the adhering means (150) melts completely to combine with the melted under-fill material (134A). However, it would be no problem if the adhering means (150) were partially un-melted. The melted under-fill material (134A) will be hardened during further heat treatment.

A terminology of “substrate” used in the present invention has the broadest meaning and is not limited to a particular semiconductor package. The present invention may be performed through various means without deviating from the spirit and essential characteristics of the present invention. For example, the embodiments of the present invention use the substrate for mounting the semiconductor chip or flip chip. It is possible to apply the manufacturing process to a BGA package or IC card. Furthermore, the under-fill material can be replaced with a new material developed by cutting-edge technology instead of epoxy group. Accordingly, the implementing examples in the embodiments of the present invention are explanatory and not limited to the specific examples.

In addition, the solder-fill used in the present invention has the broadest meaning and is not limited to a particular material described in the embodiments of the present invention. The present invention may be performed using various means without deviating from the spirit and essential characteristics of the present invention. For example, the embodiments of the present invention use unleaded solder wire or rod. It is possible to substitute unleaded solder with material made of different components. Further, the PCB could be replaced with organic material (FR4) such as Polyamid. Accordingly, the implementing examples in the embodiments of the present invention are explanatory and not limited by the specific examples.

Consequently, a new process for mounting a semiconductor chip by applying solder-fill of the present invention has advantages as listed below:

First, a process for mounting a semiconductor chip by applying solder-fill is simplified due to the reduction of the number of heat-treatments, without altering the existing facility.

Second, it is convenient and decreases the chance of mis-arranging the semiconductor chips because the solder-fill is pre-attached to the semiconductor chips and the substrate.

Third, it is possible to shorten the process of manufacturing a semiconductor chip because the solder bump on the semiconductor chip is not necessary and the solder bump manufacturing process could be eliminated.

The present invention has been described in an illustrative manner and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A process of manufacturing a solder-fill used for mounting a semiconductor chip on a printed circuit board (PCB) comprises steps of:
arranging a plurality of solder bump material, such as solder wires or rods (132) to match with a connection pattern of semiconductor chip pad and PCB in a container,
filling liquid state of under-fill material into said container,
hardening the under-fill material,
pulling out solder-fill bulk (136) which is solidified under-fill material (134) with solder bump material, and
slicing said solder-fill bulk (136) to form a unit slice of solder-fill (130).

2. The process as claimed in claim 1, wherein said under-fill material is hardened in a soft state of B-stage.

3. The process as claimed in claim 1, wherein said solder-fill bulk (136) is sliced to form a unit slice of solder-fill (130) by a diamond blade (138).
